(19) United States
(12) Patent Application Publication
(10) Pub. No.: US 2005/0280964 A1
(43) Pub. Date: Dec. 22, 2005

(54) Parallel power supply system for low voltage devices

(76) Inventors: Rebecca M. Richmond, Overland Park, KS (US); Ronald L. Carlson, Riverside, MO (US); Freeman E. Butterfield, Easton, KS (US)

Correspondence Address: FISH & RICHARDSON P.C., PO BOX 1022, MINNEAPOLIS, MN, 55440-1022, US

(21) Appl. No.: 10/871,866

(22) Filed: Jun. 18, 2004

(51) Int. Cl. H02H 3/00

(52) U.S. Cl. 361/62

(57) ABSTRACT

A load management controller (LMC) can include a power distribution circuit to supply and regulate current to a plurality of low voltage devices. In certain embodiments, the LMC may receive power from an AC power source and may further include an AC-AC transformer, a microcontroller to regulate voltage and current to user programmable levels, one or supplementary current limiters, and a plurality of receptacles to removably and electrically couple the LMC to the plurality of low voltage devices. In various embodiments, the low voltage devices comprise lights, motors, actuators, and/or audio devices.

### TECHNICAL FIELD

The invention relates to power supplies and, in particular embodiments, to parallel power supplies for low voltage devices such as ornaments.

### BACKGROUND

Electrically powered display devices are often used in displays for holidays, celebrations, special occasions and entertainment. Some displays powered by electricity may be used in storefronts and other commercial displays to attract attention or to provide amusement. Such display devices may include visual elements, such as light displays of various kinds. Other display devices may provide audio elements, such as music, singing, synthesized voices, or natural sounds. Other displays may involve motion or rotation of objects. Some displays include combinations of audio and visual elements in an integrated display to provide the observer with an enhanced experience.

When operating electrical devices, current and voltage levels must be supplied at levels appropriate to the electrical load of each device. Some devices, for example, require an alternating current (AC) power source, while others may require a direct current (DC) power source. Some electrical loads may accept only a narrow range of input voltages, while other devices may be operated over a wider range of voltages. For example, some types of light devices may be “dimmed” to provide various levels of illumination. As such, each electrically powered device in a display must be supplied by an appropriate power source.

Displays that require multiple power sources to supply electrical power to multiple devices typically require a separate source of AC or DC power for each device. In some cases, this may typically involve a number of extension cords, wall outlets, or sets of batteries. To reduce the danger of electrical shock and the risk of fire from an over-current condition, each separate power source may provide protection against circuit faults.

### SUMMARY

A load management controller (LMC) can include a power distribution circuit to supply and regulate current to a plurality of low voltage devices. In certain embodiments, the LMC may receive power from an AC power source and may further include an AC-AC transformer, a microcontroller to regulate voltage and current to user programmable levels, one or supplementary current limiters, and a plurality of receptacles to removably and electrically couple the LMC to the plurality of low voltage devices. In various embodiments, the low voltage devices comprise lights, motors, actuators, and/or audio devices.

In certain embodiments, the LMC may provide output power in other forms, such as variable AC (dimmer), intermittent AC, DC, and variable DC. The LMC may optionally include circuit protection devices and equipment. For example, circuit breakers, fuses, and positive temperature coefficient resistors may provide circuit protection. Circuit protection may include a main protection element, as well as branch protection elements for one or more output branches.

In still another embodiment, the LMC microcontroller may monitor faults and execute instructions to operate one or more display elements. The LMC may, in some examples, be configured to accept user programming to specify the operation of display elements in a desired manner.

Some embodiments may provide one or more of the following advantages. High current output capacity may provide sourcing capacity for a number of loads. This may reduce the number of power sources required for a display, and may enable displays in areas lacking multiple outlets. Moreover, high current capacity may improve brightness levels of displays and enhance an observer's viewing experience. Over-current protection may be provided for multiple loads and may also be provided for individual loads. A low voltage level may reduce the risk of electrical shock hazard potential. Portability may reduce the number and length of power cords in a display, resulting in an uncluttered appearance.

The details of one or more embodiments of the invention are set forth in the accompanying drawings and the description below. Other features, objects, and advantages of the invention will be apparent from the description and drawings, and from the claims.

### DESCRIPTION OF DRAWINGS

FIG. 1 is a perspective view of a load management system including a power supply and a load management controller.

FIG. 2 is a schematic of a power supply and load management controller.

FIG. 3 is a circuit diagram of a detachable load management controller.

FIG. 4 is a circuit diagram of a load management controller and various load devices.

FIGS. 5A and 5B are schematics of illustrative transformers.

FIG. 6 is a block diagram of an illustrative load management controller.

Like reference symbols in the various drawings indicate like elements.

### DETAILED DESCRIPTION OF ILLUSTRATIVE EMBODIMENTS

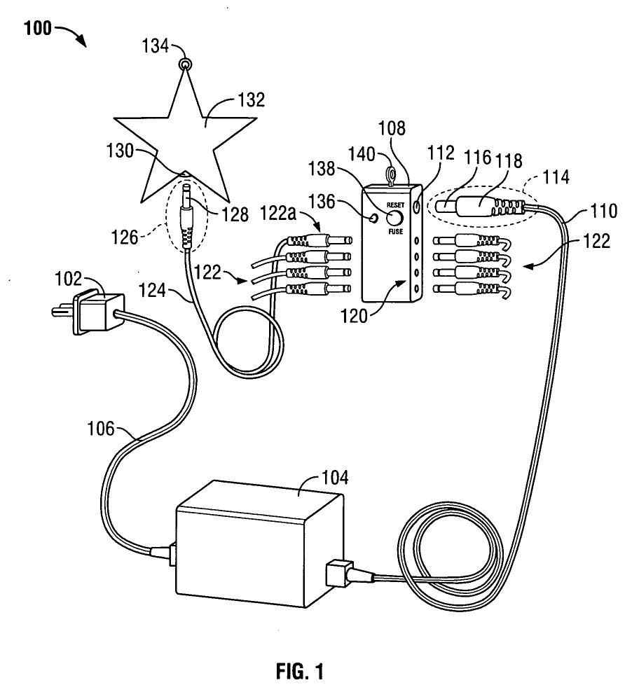

FIG. 1 shows, in one example, a front perspective view of a load management system 100 that may be used to manage power distribution to electrical devices, such as display ornaments. A two-pronged electrical plug 102 may be inserted into an electrical outlet, such as a conventional 120-Volt, 60-Hertz wall outlet, so that an alternating current (AC) signal is provided to power supply 104. Electrical plug 102 may be polarized, for example, and a three-pronged plug or other types of conventional electrical plugs may alternatively be used. Power supply 104 may be used to size and condition the AC signal to appropriate voltage and current levels for powering various ornaments, displays, exhibits, etc., and may be electrically connected to plug 102 by a conventional two-conductor insulated electrical cord 106. In one embodiment, power supply 104 provides an output AC signal of about 6 Volts at up to 4 amps. This output AC signal may then be delivered to a load management controller 108 via an insulated, two-conductor cable 110, which may attach to power supply 104.

The load management controller (LMC) 108 may be used to provide relatively low-voltage and high-current AC output signals for powering AC loads. As such, a user's risk of electrical shock may be reduced because of the relatively low voltage of the output AC signal, thus providing a safer environment for displaying AC-powered ornaments and other types of AC loads. Moreover, because a relatively high current capacity is provided, a large number of loads may be powered by the load management system 100, facilitating the creation of complex displays having a diverse variety of ornaments, for example. Furthermore, brightless levels of lighted ornaments may be improved, enhancing the appearance of the display.

The AC signal from power supply 104 enters the LMC 108 at an input port 112, to which connector 114 may attach. Connector 114 includes a plug 116 that may be inserted into input port 112. Plug 116 is electrically connected to cable 110, and may include two conductors that are suitable for conducting the AC signal from the power supply 104 to the LMC 108. In one embodiment, LMC input port 112 is a receptacle for a female plug and plug 116 is a female plug, but port 112 could be receptacle for a male plug and plug 116 could be a male plug, and those skilled in the art will recognize that other electrical connecting mechanisms are possible. Plug 116 may be partially enclosed in a flexible elastomer 118 to provide stress relief, strength, support and insulated protection for the connector 114.

LMC 108 may provide a plurality of output ports 120, to which output connectors 122 may attach. FIG. 1 shows an embodiment having four output ports 120 on one side of LMC 108, and representations of four corresponding output connectors 122 just to the right of the output ports 120. Four additional output ports 120 (not shown in FIG. 1) are on the opposite side of the LMC 108. This is symbolized by the four output connectors 122 shown to the left of LMC 108 in FIG. 1. Each of the output connectors 122 includes a plug and a flexible elastomer to make an electrical connection with the output port 120 and provide stress relief, respectively. In one embodiment, the LMC output ports 120 are receptacles for male plugs and each of the output connectors 122 includes a male plug, but female plugs or other suitable variants can be sued.

Output connector 122a is coupled to a proximal end of an interconnect cable 124, and a similar connector 126 is coupled to a distal end of the interconnect cable 124. Connector 126 includes a plug 128 that may be inserted into a receptacle 130 of an ornament 132 to provide AC power to the ornament 132. The ornament 132 in FIG. 1 is in the shape of a star, and may be hung by an attached hook 134, for example, from a Christmas tree, as part of a birthday, anniversary, wedding or graduation display, or as part of a nighttime scene in a school play. Ornament 132 may be an AC-powered ornament that lights up when powered by an AC signal. For example, the star may contain numerous miniature white light bulbs (not shown) connected in parallel or in series and powered by the AC signal presented at receptacle 130 through connector 126 over interconnect cable 124 from connector 122a connected to LMC output port 120 and provided by LMC 108. Other colors of lights may be used, and the LMC may cause the lights to alternatively flash intermittently, in a defined sequence, and/or at various levels of brightness.

LMC 108 additionally includes an indicator light 136 that may indicate when input power is applied to the LMC 108. For example, indicator light 136 may be a green light-emitting diode (LED) that turns on when connector 114 supplies an input AC signal to LMC 108 at input port-112. In other embodiments, additional indicator lights 136 of various colors and shapes may be used to indicate fault conditions, warning notifications or other user information. In some embodiments, a speaker may additionally provide tones or warning messages to simultaneously or independently alert a user to such conditions.

A button 138 may allow a user to reset a current-limiting element, such as a fuse or a circuit breaker. Non-resettable current-limiting devices, such as a positive temperature coefficient (PTC) resistor, may also be used. The current limiting element protects the LMC 108 from over-current situations such as a short on one or more of the outputs or a low impedance fault, each of which could otherwise be harmful to the various components of the load management system 100. The user might be alerted to the need to reset the current limiting element, for example, by an LED indicator on the LMC 108, and may then press button 138 to execute the reset.

LMC 108 may be suspended from a support member by an attached loop hanger 140. For example, LMC 108 may be hung from a branch of a Christmas tree, which may place LMC 108 in close proximity to ornaments 132 also hanging from the tree, thereby minimizing the required length of interconnect cables 124. Moreover, loop hanger 140 may permit LMC 108 to be hung from a support member such that it is hidden from view, if so desired, thus permitting display viewers to focus on the display without distraction. Of course, LMC 108 need not be suspended using loop hanger 140, and other types of hanging devices may be used, such as a hook, a clamp or the like.

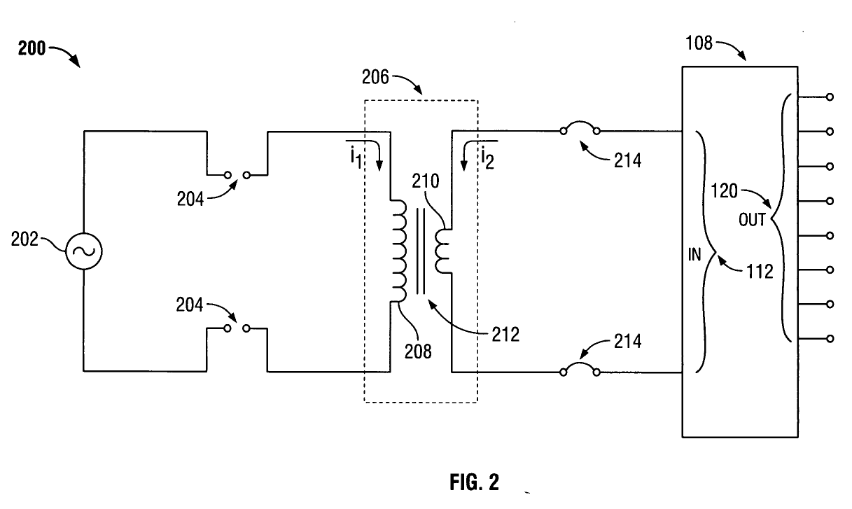

FIG. 2 is a schematic of the load management system of FIG. 1. An alternating current source 202 with electrical receptacles 204 represents a wall outlet, into which electrical plug 102 may be inserted to complete a circuit to a transformer 206, which may reside within power supply 104. As is conventional, transformer 206 includes a primary winding 208 magnetically coupled to a secondary winding 210 through a magnetic core, which is represented by vertical lines 212 in FIG. 2. A first AC signal i₁ flows from the source 202 through the primary winding 208 when electrical plug 102 is inserted into electrical receptacles 204, and produces a magnetic flux in the magnetic core 212 that induces a second AC signal i₂ through the secondary winding 210 of the transformer 206. As is conventional, signal i₂ may be sized as desired by adjusting the number of turns in the windings 208, 210 of transformer 206. The details of transformer operation are well known in the art and will not be discussed further here.

Connections 214 in FIG. 2 represent cable 110, and couple LMC 108 to the transformer 206 that is within power supply 104. LMC 108 is shown receiving AC signal i₂ at input port 112. In one embodiment, the LMC 108 provides eight output ports 120 for powering up to eight loads, as shown in FIG. 2.

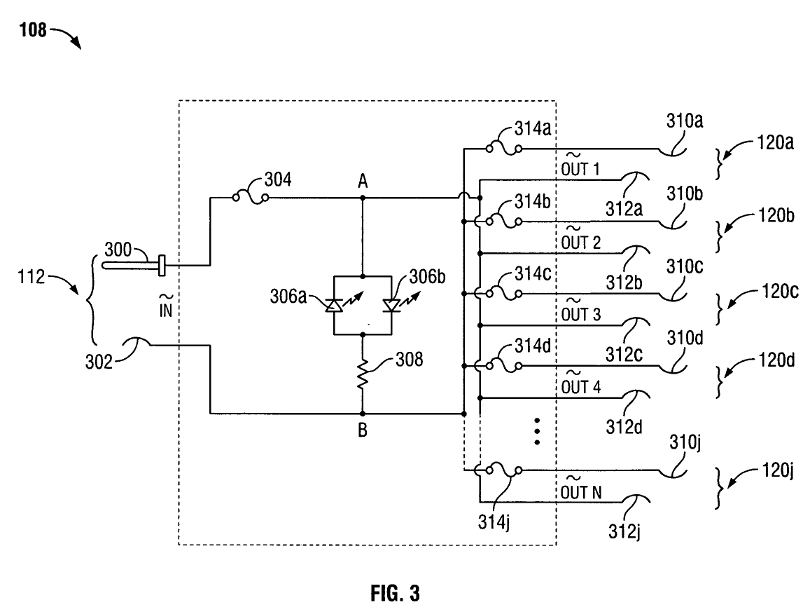

FIG. 3 is a circuit diagram of the LMC 108. Input port 112 is a receptacle for a female plug, and includes a male post 300 and a common contact 302. Female plug 116 may be inserted into input port 112 to provide a proper electrical connection between the LMC 108 and the power supply 104 so that an AC signal from power supply 104 can be delivered to the LMC 108 over cable 110. Male post 300 is connected to a resettable current limiting element 304.

FIG. 3 shows the current limiting element 304 as a fuse, which may be sized to blow when total current draw from the output loads 132 exceeds a threshold value corresponding to the rated current supply capacity of the power supply 104. For example, if the power supply 104 is rated for a maximum output current level of 4.5 amps, an appropriate current limiting element 304 may be a 4.4 amp fuse. In this example, if the total current draw from the output loads 132 were to reach 4.4 amps, current limiting element 304 would blow and create an open circuit condition, immediately interrupting current flow and preventing damage to power supply 104 by ensuring that its output current did not exceed 4.4 amps. Current limiting element 304 could similarly be sized to protect the various AC load combinations that LMC 108 may manage. Other suitable current limiting elements include circuit breakers and PTC resistors. A user may reset the resettable current limiting element 304, for example, by pressing button 138.

Resettable current limiting element 304 is connected at node A to a pair of light-emitting diodes 306. The diodes are in a bidirectional arrangement, with the cathode of diode 306a connected to the anode of diode 306b and to current limiting element 304 at node A. The anode of diode 306a is then connected to the cathode of diode 306b, and also to a current limiting resistor 308. The current limiting resistor is connected at node B to the common contact 302 of input port 112, and may be selected to draw an appropriate current through diodes 306. In one embodiment, resistor 308 may be sized at 220 ohms and diode 306b corresponds to indicator light 136 in FIG. 1.

The output ports 120 are shown at the right side of the LMC 108. In the embodiment shown in FIG. 3, each output port 120 is a receptacle for a male plug and includes first 310 and second 312 contact points. A male plug may be inserted into an output port 120 to provide a proper electrical connection between the LMC 108 and an AC load (such as ornament 132) so that an AC signal from the LMC 108 can be delivered to the ornament 132 over interconnect cable 124. The output ports 120 are connected in parallel, and each of the output ports 120 includes an output fuse 314, which may be sized to individually protect the corresponding output load 132 that may be attached to each of the individual output ports 120a, 120b, 120c, 120d, . . . , 120j. Each output fuse 314 is connected at one terminal to node B, and at the other terminal to the corresponding first contact point 310 at the corresponding output port 120. The second contact point 312 of each output port 120 is connected to node A.

Output fuses 314a-314j are optional, as is resettable current limiting device 304. The output fuses 314 could similarly be resettable by a user, for example by pushing a button on the LMC 108, and could be replaced by circuit breakers or PTC resistors. In one embodiment, output fuses 314 may be sized at 0.5 amps to ensure that output current to an AC load never exceeds 0.5 amps, thereby protecting the loads from over-current damage. Both the input port 112 and output ports 120 may have staggered contact points so that a user who might accidentally touch an outermost edge of the port will be protected from electrical shock because the second contact point is set back in the port 112, 120. This may prevent injury to a user and provide a safer environment for attaching connectors 114, 122 to the LMC 108. Moreover, because the ports 112, 120 may be gender-specific receptacles, a user who attempts to incorrectly attach a connector 114, 122 to the LMC 108 will be alerted to the error when the receptacle fails to engage the connector, and the mistake can be corrected.

Over-current situations can be accordingly avoided by providing primary and/or secondary fuses, circuit breakers, or other current limiting devices. IC (integrated circuit) current limiters together with any necessary rectifiers and inverters (depending on whether inputs and outputs are AC or DC) could be coupled between the input and output terminals. Multiple IC current limiters could additionally or alternately be used in place of elements 314a-314j. Another approach to limit current is to equip the output connectors 122 with insulative plugs adapted to seal one or more adjacent output plugs. Accordingly, devices which draw relatively large amounts of current can be equipped with such plugs so as to reduce the number of devices that can be plugged into LMC 108 and thereby prevent an over-current situation.

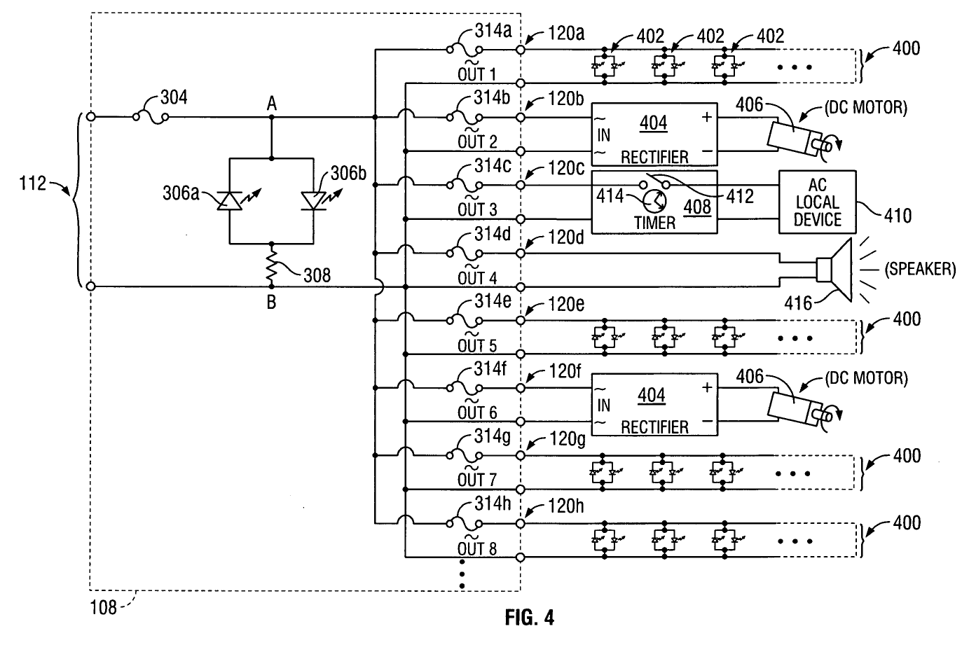

FIG. 4 shows the LMC 108 with various load devices attached to the output ports 120. A generic representation of input port 112 is depicted, while the resettable current limiting device 304, LEDs 306 and current-limiting resistor 308 are shown unchanged from FIG. 3. Eight output ports 120a-h are shown in the embodiment of FIG. 4, and each output port 120a-h has a corresponding individual output fuse 314a-h. As such, each output fuse 314a-h may individually protect its corresponding output load from over-current situations, and if one or more high-current situations cause one or more individual output fuses 314a-h to blow, the other output ports may be unaffected, thereby providing a robust operating environment and minimizing downtime for a given display.

A string of lights 400 includes bidirectional light pairs 402 connected in parallel and attached to output port 120a. The lights 400 may be a string of decorative holiday lights, for example, and may be powered by an AC signal provided by output port 120a. Similarly, strings of lights 400 are attached to output ports 120e, 120g and 120h. Each of the light strings 400 may contain lights 402 of the same color, or alternatively the lights 402 may be different colors as desired. Series-connected loads may also be powered.

A rectifier 404 is attached to output port 120b and converts an input AC signal to an output direct current (DC) signal suitable for powering a DC load, such as a DC motor 406. The rectifier may optionally be positioned inside the LMC 108. In the depicted embodiment, the DC output ports may provide an alternative power source for some battery-operated devices. The DC motor might be used to provide motion to displays and exhibits, enabling the creation of more complex and interesting displays. For example, perhaps one item in a planetary display consists of a model of Jupiter mounted above a base on an axis that runs through the model planet. The DC motor 406 may be concealed under the base and used to rotate the axis, causing the model of Jupiter to spin on the axis. Similarly a rectifier/motor combination 404/406 attached to output port 120f may be used to rotate a model of Saturn, or one or more of Jupiter's moons in the planetary display. The light strings 400 might be used to represent distant star constellations in the display, for example. Additional rectifier/motor loads may be added to correspond to the other planets in the solar system, for example.

A timer 408 is attached to output port 120c and also to a local AC device 410. Similarly to the rectifier, the timer may be positioned within LMC 108. The timer 408 facilitates intermittent loads and includes a switch 412 for making or breaking a connection between the output port 120c and the AC device 410, and a dial 414 to permit a user to control the operation of the switch 412. In this example, AC device 410 may be an ornament representing the title of the display and may blink on and off according to a user-defined pattern programmed into timer 408 using dial 414. A speaker 416 is attached to output port 120d and may add sound to the exhibit, for example by playing music. As such, complex displays having various types of ornaments, exhibits and effects are possible using load management system 100.

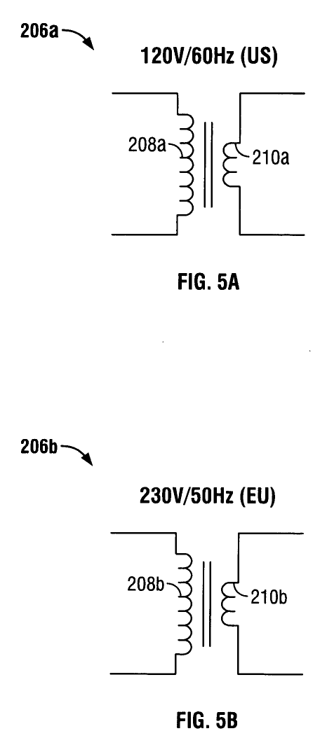

FIG. 5A shows one embodiment of the transformer 206 in FIG. 2. Referring to FIG. 5A, transformer 206a includes a primary coil 208a and a secondary coil 210a. In this embodiment, transformer 206a is a step-down transformer and is sized to produce an output AC signal i₂ of about 6 Volts at up to 4 Amps when presented with a conventional input AC signal i₁ of 120 Volts at 60 Hertz, as is commonly available in the United States. FIG. 5B shows another embodiment where transformer 206b includes a primary coil 208b and a secondary coil 210b, and is likewise a step-down transformer, this time sized to produce the same output signal i₂ given the conventional European input AC signal i₁ of 230 Volts at 50 Hertz.

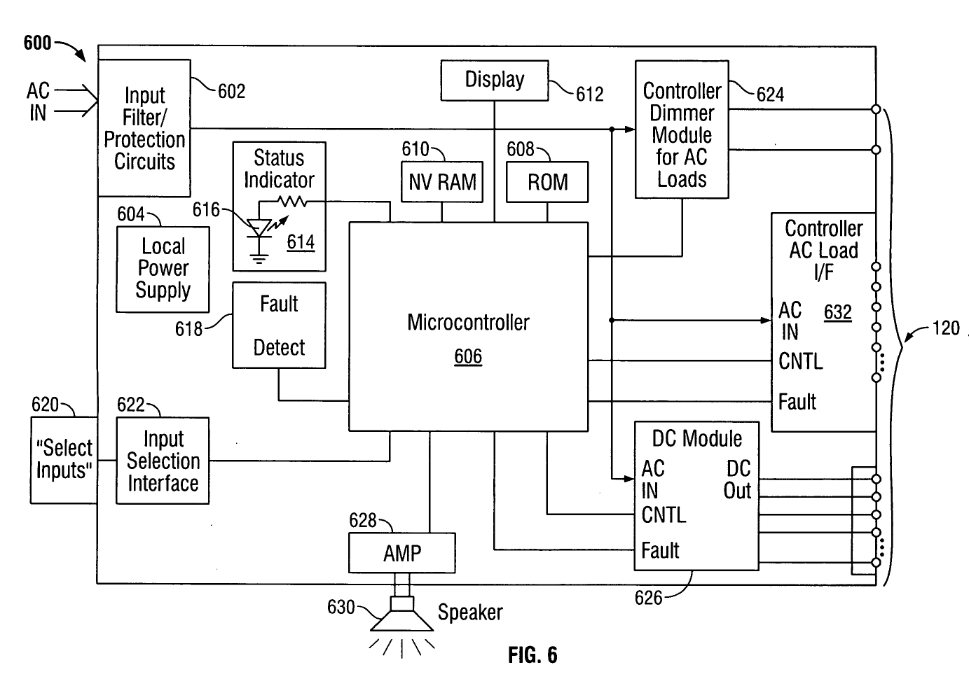

FIG. 6 shows another embodiment of a load management controller. LMC 600 includes input filter and protection circuits 602 to condition the received input AC signal at input port 112 and provide protection against electro-static dissipation (ESD) to protect the circuitry of the LMC 600, for example, as is known in the art. A local power supply module 604 provides the operating DC voltages to various modules within the LMC 600, such as 12V, 5V, 3.3V, 2.5V, 1.8V, 1.5V, 1.2V, etc., and may also provide differential voltage signals.

A microcontroller 606 may execute software instructions to perform algorithms and tasks associated with managing the various functions of the LMC 600. As is conventional, the software instructions may initially be stored in non-volatile memory 608 such as read-only memory (ROM), flash memory, electronically programmable read-only memory (EPROM), electrically erasable programmable read-only memory (EEPROM) and the like. Non-volatile memory 608 may be updatable, such that software updates may be provided or downloaded to the LMC 600, for example by using a JTAG interface, a dedicated reprogram header and cable, or by replacing a socketable chip. Reprogramming the LMC may be accomplished, for example, by wired or wireless communication over the Internet or a Bluetooth connection with provision of suitable transceivers and controllers. LMC 600 may be reprogrammed using a personal computer, personal digital assistant (PDA), cell phone, or any other appropriate device. LMC 600 may include a telemetry module (not shown) to facilitate wireless communication with external devices.

As is conventional, the software instructions may be loaded from non-volatile memory 608 to a local memory 610, from which microcontroller 606 may access the instructions and execute them. Memory 610 may be static random access memory (RAM), non-volatile random access memory (NVRAM), dynamic RAM (DRAM) or the like. Of course, memories 608 and 610 may be incorporated within the microcontroller, or may be combined in a single device. A display 612 allows text or display messages to be presented to a user. In one embodiment, display 612 includes a liquid crystal display (LCD) and associated drive circuitry. Display 612 may be backlit to provide ease of readability in low lighting conditions and may include sleep modes that dim or turn off the display 612 during periods of non-use.

Similarly, LMC 600 may include a group of status indicator lights 614, represented in FIG. 6 by an LED 616. The status indicator lights 614 may be controlled by the microcontroller 606 to represent the present operating status of LMC 600. For example, one status indicator light may be green and may be turned on by microcontroller 606 when the LMC 600 is functioning properly. Moreover, one or more yellow status indicator lights may indicate a warning, and one or more red indicator lights may indicate that an error has occurred when turned on by the microcontroller 606. A fault detect module 618 may detect faults and errors as they occur and may then notify the microcontroller 606 of the condition, for example, by initiating an interrupt to the microcontroller 606 or by setting an appropriate input line to be polled by the microcontroller 606. The microcontroller 606 may then turn on or turn off the appropriate status indicator lights 614, or may flash a user message on the display 612. Alternatively, the fault detect module 618 may include circuitry to drive the status indicator lights 614 without interrupting the operation of the microcontroller 606.

A group of selection inputs 620 permit a user to select between various modes of operation or otherwise specify input parameters relevant to the operation of the LMC 600. Inputs 620 may include toggle switches, jumpers, buttons, and multi-position switches such as slide switches. An input selection interface module 622 includes filtering and protection circuitry for the selection inputs 620, and passes the inputs to the microcontroller 606. For example, a user may activate inputs 620 to enable or disable a group of output ports 120, or to select an activation sequence among the output ports 120. Some inputs 620 may further clear or reset fault or warning conditions. Used independently or in conjunction with display 612, inputs 620 may further be used to program LMC 600 to execute various display management operations. For example, LMC 600 may be programmed to manage three distinct displays patterns for a given set of output loads. One pattern might be displayed in the morning, another in the afternoon, and a third in the evening, with a user specifying the correct pattern using inputs 620. Alternatively, microcontroller 606 may include a real-time clock and automatically switch between display patterns as appropriate.

FIG. 6 shows several embodiments of output ports 120 and associated modules. A dimmer module 624 includes circuitry for varying the current or voltage level presented to one or more associated output ports 120. Selection inputs 620 may be used to control dimmer module 624, or microcontroller 606 may program the dimmer module to an appropriate setting. As such, various levels of brightness may be realized for display light strings 400 or other lighted ornaments when attached to a corresponding output port 120.

A DC module 626 includes a rectifier circuit and various voltage regulators to provide DC output voltages at corresponding output ports 120 to power DC loads, which may previously have required battery power. For example, DC module 626 may source output ports 120 at 12V, 9V, 6V, 5V, 4.5V, 3V and 1.5V. This may provide a more convenient and environmentally friendly power solution than replaceable batteries, as well as potentially minimizing both downtime and maintenance time.

An amplifier circuit 628 drives a speaker 630, which may be incorporated within LMC 600 or external. Selection inputs 620 may be used to set the volume, bass or treble levels of the speaker 628, for example. An AC load interface module 632 controls a group of AC output ports 120, and may provide power for light, sound, or motion display elements.

The components shown in FIG. 6 are optional, or may be combined with one or more of the remaining components in various fashions. Busses (data, address, memory, power, etc.) are not shown in FIG. 6, and the connections between modules are meant to be merely representative. An application specific integrated circuit (ASIC) or field programmable gate array (FPGA) could alternatively replace one or more of the modules in FIG. 6.

A number of embodiments of the invention have been described. Nevertheless, it will be understood that various modifications may be made without departing from the spirit and scope of the invention. For example, LMC input ports 112 and output ports 120 could be located on any side of the LMC 108, and the number of each type of port 112, 120 may be varied. For example, LMC 108 may have two input ports 112, and may have eight, ten, twelve, sixteen, twenty, or any other number of output ports 120. Similarly, indicator lights 136 and buttons 138 may be located on any side of LMC 108 and various numerical combinations of each are possible. Accordingly, other embodiments are within the scope of the following claims.

1-16. (canceled)

17. A method for supplying alternating current (AC) to a plurality of ornaments, the method comprising:
providing a transformer having a primary winding and a secondary winding, the primary winding to couple to an AC power source, the secondary winding coupled to the primary winding and sized to provide a stepped-down AC signal;
providing a load management controller (LMC) comprising:
a first input electrically coupled to the stepped-down AC signal;
a plurality of AC output ports to couple AC loads to the LMC; and
at least one current limiter to substantially prevent the current at said first input from exceeding a predetermined threshold; and
indicating power or fault status of the LMC.

18. The method of claim 17, wherein the LMC further comprises a controllable voltage regulator to selectively adjust at least one voltage supplied to the one or more AC output ports.

19. The method of claim 17, wherein the LMC further comprises a controller to selectively control the voltage or current supplied to each ornament according to a predetermined sequence.

20. The method of claim 17, wherein the LMC further comprises:
a direct current (DC) output port for coupling DC loads to the LMC; and
a voltage converter that converts the stepped-down AC signal to provide a regulated DC signal to the DC output port.

21. The method of claim 17, wherein the voltage supplied to one or more of the AC output ports is approximately 6 volts AC.

22. The method of claim 17, wherein the current limiter is resettable.

23. The method of claim 17, wherein the LMC further comprises at least one additional current limiter arranged to substantially prevent electrical current passing through at least one of AC output ports from exceeding a predetermined threshold.

24. The method of claim 17, wherein at least one of the AC output ports comprises a receptacle for a plug to make electrical connection to a load.

25. A method for supplying direct current (DC) to a plurality of ornaments, the method comprising:
providing a transformer having a primary winding and a secondary winding, the primary winding coupled to an alternating current (AC) power source, and the secondary winding coupled to the primary winding to provide a stepped-down AC signal;
providing a load management controller (LMC) comprising:
a first input electrically coupled to the stepped-down AC signal;
a DC module that converts the stepped-down AC signal to one or more regulated DC signals;
a plurality of DC output ports to couple the regulated DC signals to DC loads; and
a current limiter to substantially prevent the current at the first input from exceeding a predetermined threshold, and
indicating power or fault status of the LMC.

26. The method of claim 25, wherein the DC module further comprises one or more voltage regulators that provide one or more of the regulated DC signals.

27. The method of claim 26, wherein at least two of the voltage regulators provide regulated DC signals at voltages that are substantially different.

28. The method of claim 26, wherein the voltage supplied to at least one DC load coupled to the DC output ports is adjusted in response to a control signal.

29. The method of claim 28, wherein the control signal is generated in response to a user input.

30. The method of claim 28, wherein the LMC further comprises a processor that executes program instructions that, when executed by the processor cause the processor to generate the control signal.

31. The method of claim 30, wherein the program instructions, when executed by the processor, further cause the processor to generate a predetermined sequence of control signals that cause voltage supplied to at least one of the DC loads to be adjusted in a predetermined pattern.

32. The method of claim 28, wherein adjusting the voltage comprises alternately supplying and discontinuing power supplied to at least one DC load.

33. The method of claim 28, wherein adjusting the voltage comprises modulating the voltage or current supplied to at least one DC load.

34. The method of claim 25, wherein the LMC is configured to supply to at least one of the DC output ports at least about 0.5 Amp on a continuous basis.

35. The method of claim 25, wherein the LMC is configured to supply to at least one of the DC output ports at least about 0.5 Amp on a continuous basis at a voltage of approximately 6 volts DC.

36. The method of claim 25, wherein the LMC comprises a plurality of DC output ports, and the LMC is configured to supply to each DC output port at least about 0.5 Amp on a continuous basis at a voltage of approximately 6 volts DC.

37. The method of claim 36, wherein the LMC is further configured to supply to each DC output port at least about 0.5 Amp on a continuous basis at a voltage of approximately 6 volts DC.

38. The method of claim 25, wherein the LMC further comprises an AC output port for coupling AC loads to the LMC.

39. The method of claim 25, wherein the LMC further comprises at least one additional current limiter, wherein each additional current limiter is arranged to substantially prevent electrical current that conducts through any of the DC output ports from exceeding a predetermined threshold.

40. The method of claim 25, further comprising coupling to one of the DC output ports at least one electrically-operated ornament that articulates when operated.

41. The method of claim 25, further comprising coupling at least one electrically-operated ornament to any of the DC output ports, wherein the at least one ornament is selected from the group consisting of: a string comprising a plurality of incandescent lamps; a string comprising a plurality of light emitting diodes (LEDs); an ornamental object that articulates in response one of the regulated DC signals; and an electrically-operated device that outputs a predetermined audio message when operated.

42. The method of claim 25, wherein the LMC further comprises:
a memory containing program instructions; and
a processor configured to execute the program instructions to perform operations.

43. The method of claim 42, wherein the operations comprise controlling the illumination of at least one light emitting diode (LED) or incandescent lamp coupled to an ornament.

44. The method of claim 42, wherein the operations comprise controlling an audio output device to produce an audible output signal.

45. The method of claim 44, wherein the operations further comprise controlling illumination of an ornament in coordination with the audible output signal.

46. The method of claim 25, further comprising supplying an aggregate current of up to about 4 Amps on a continuous basis to loads coupled to any of the DC output ports.

47. The method of claim 25, wherein the current limiter comprises a fuse.

48. The method of claim 25, wherein indicating power or fault status is indicated in response to a current in the LMC exceeding a predetermined threshold.

49. The method of claim 25, wherein the DC load comprises an electrical connector configured to be removably coupled to one of the output port, and further comprises an insulative extension portion that blocks one or more adjacent output ports when the electrical connector is coupled to one of the output ports.
